(19) United States
(12) Patent Application Publication
(10) Pub. No.: US 2012/0164901 A1
(43) Pub. Date: Jun. 28, 2012

(54) NONWOVEN WEBS HAVING IMPROVED BARRIER PROPERTIES

(75) Inventors: Ali Yahiaoui, Roswell, GA (US); Anthony S. Spencer, Woodstock, GA (US); Stephen L. Kaplan, San Carols, CA (US)

(73) Assignee: KIMBERLY-CLARK WORLDWIDE, INC., Neenah, WI (US)

(21) Appl. No.: 12/976,077

(22) Filed: Dec. 22, 2010

(51) Int. Cl. D04H 13/00; B05D 1/36; B05D 3/06; B05D 7/24; B05D 5/00; B05D 3/10

(52) U.S. Cl. 442/59; 427/488

(57) ABSTRACT

Methods of manufacturing a nonwoven web having alcohol repellency properties are provided. A plurality of perfluoroalkyl(alkyl)(meth)acrylic monomers can first be deposited on a surface of the nonwoven web, and subsequently exposed to a RF plasma to polymerize the monomers on the surface of the nonwoven web to form a fluorinated polymeric coating. The perfluoroalkyl(alkyl)(meth)acrylic monomers include perfluoroalkyl(alkyl)(meth)acrylate esters having a perfluorinated carbon end group of 1 to 6 carbon atoms

Nonwoven webs are also generally provided that have an alcohol repellency of greater than 80%.

### BACKGROUND OF THE INVENTION

Nonwoven fabrics are useful for a wide variety of applications, such as in wipers, towels, industrial garments, medical garments, medical drapes, sterile wraps, etc. It is not always possible, however, to produce a nonwoven fabric having all desired attributes for a given application. As a result, it is often necessary to treat nonwoven fabrics by various means to impart desired properties. For example, in some applications, barrier properties to organic solvents and oil penetration are desired.

Fabrics that can repel organic solvents can be achieved by fluorination of the material surface(s). Such fluorination has traditionally been performed by surface grafting fluorinated acrylic monomers bearing an end chain having at least 8 perfluorinated carbons. In particular, the conventional wisdom in the art is that liquid repellency or barrier properties to organic solvents reduces significantly with less than 8 perfluorinated carbons due to the shorter perfluorinated carbon chain making the polymer more receptive to organic solvents, as discussed in “Molecular Aggregation Structure and Surface Properties of Poly(fluoroalkyl acrylate) Thin Films”, K. Honda, et al., Macormolecules, 2005, 38, p. 5699-5705. The chain length of the fluorinated acrylic monomer directly impacts its chemical repellency performance, with shorter chain lengths reducing its liquid repellency property.

However, fluorinated acrylic monomers bearing an end chain having at least 8 perfluorinated carbons, and their resulting products and polymers, have significant environmental disadvantages. In particular, these fluorinated acrylic products bearing end chains having at least 8 perfluorinated carbons (“C8”) are associated with perfluorooctanoic acid (PFOA) either as a processing aid residue during manufacturing or as a potential decomposition by-products of a C8 compound.

PFOA is a synthetic chemical that does not occur naturally in the environment, but has become very persistent in the environment and found at very low levels both in the environment and in the blood of the general U.S. population. Additionally, PFOA has been found to remain in people for a very long time and has been shown to cause developmental and other adverse effects in laboratory animals. These disadvantages of PFOA are so profound that the U.S. Environmental Protection Agency (EPA), in cooperation with major companies in the industry, launched the “2010/15 PFOA Stewardship Program,” in which companies committed to reduce global facility emissions and product content of PFOA and related chemicals by 95 percent by 2010, and to work toward eliminating emissions and product content by 2015.

Accordingly, there exists a need for a nonwoven fabric having suitable liquid repellency or barrier properties to organic solvents and oil penetration without the presence of fluorinated acrylic monomers bearing an end chain having at least 8 perfluorinated carbons and without the use of PFOA as a chemical in the manufacturing and without the risk of yielding PFOA by-product.

### SUMMARY OF THE INVENTION

Methods are generally provided of manufacturing a nonwoven web having alcohol repellency properties. A plurality of (meth)acrylic monomers can first be deposited on a surface of the nonwoven web, and subsequently exposed to a pulsed RF plasma (e.g., having a frequency of about 10 Hz to about 2.5 GHz) to polymerize the monomers on the surface of the nonwoven web to form a fluorinated polymeric coating.

Nonwoven webs are also generally provided that have an alcohol repellency of greater than 80%. The nonwoven web includes a plurality of fibers and defines a surface on which a fluorinated polymeric coating is grafted. The fluorinated polymeric coating is formed by polymerizing a plurality of (meth)acrylic monomers on the surface of the nonwoven web to form a (meth)acrylic polymer.

In these embodiments, the (meth)acrylic monomers comprise a perfluoroalkyl side groups having 1 to 6 carbon atoms. For example, the (meth)acrylic monomers can include perfluoroalkyl(alkyl)(meth)acrylic monomers, such as those perfluoroalkyl(alkyl)(meth)acrylic monomers having the structure:

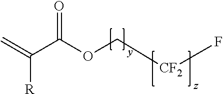

where R is H or CH₃; y is an integer from 0 to 22; and z is an integer from 1 to 6.

Accordingly, the nonwoven web has an alcohol repellency of greater than 80%, such as greater than about 90%, such as greater than about 95%.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of a process that may be used in one embodiment of the present invention to form a nonwoven laminate;

FIG. 2 shows an exemplary SMS laminate for use according to one embodiment of the present invention;

FIG. 3 shows an embodiment of an SMS laminate as in FIG. 2 after formation of a fluorinated polymeric coating on one surface;

FIG. 4 shows another embodiment of an SMS laminate having a first fluorinated polymeric coating one surface and a second fluorinated polymeric coating on the opposite surface;

FIG. 5 shows yet another embodiment of an SMS laminate having a metalized layer between its surface and the fluorinated polymeric coating;

FIG. 6 shows yet another embodiment of an SMS laminate having a first metalized layer between the one surface and a first fluorinated polymeric coating and a second metalized layer between the opposite surface and the second fluorinated polymeric coating; and

FIG. 7 shows an exemplary system for deposition of the perfluoroalkyl(alkyl)(meth)acrylic monomers and subsequent polymerization to form the fluorinated polymeric coating.

Repeat use of references characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

### Definitions

As used herein, the term “fibers” refer to elongated extrudates formed by passing a polymer through a forming orifice such as a die. Unless noted otherwise, the term “fibers” includes discontinuous fibers having a definite length and substantially continuous filaments. Substantially filaments may, for instance, have a length much greater than their diameter, such as a length to diameter ratio (“aspect ratio”) greater than about 15,000 to 1, and in some cases, greater than about 50,000 to 1.

As used herein, the term “monocomponent” refers to fibers formed one polymer. Of course, this does not exclude fibers to which additives have been added for color, anti-static properties, lubrication, hydrophilicity, liquid repellency, etc.

As used herein, the term “multicomponent” refers to fibers formed from at least two polymers (e.g., bicomponent fibers) that are extruded from separate extruders. The polymers are arranged in substantially constantly positioned distinct zones across the cross-section of the fibers. The components may be arranged in any desired configuration, such as sheath-core, side-by-side, pie, island-in-the-sea, and so forth. Various methods for forming multicomponent fibers are described in U.S. Pat. No. 4,789,592 to Taniquchi et al. and U.S. Pat. No. 5,336,552 to Strack et al., U.S. Pat. No. 5,108,820 to Kaneko, at al., U.S. Pat. No. 4,795,668 to Krueqe, at al., U.S. Pat. No. 5,382,400 to Pike, et al., U.S. Pat. No. 5,336,552 to Strack, at al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

As used herein, the term “multiconstituent” refers to fibers formed from at least two polymers (e.g., biconstituent fibers) that are extruded from the same extruder. The polymers are not arranged in substantially constantly positioned distinct zones across the cross-section of the fibers. Various multiconstituent fibers are described in U.S. Pat. No. 5,108,827 to Gessner, which is incorporated herein in its entirety by reference thereto for all purposes.

As used herein, the term “nonwoven web” refers to a web having a structure of individual fibers that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

As used herein, the term “meltblown” web or layer generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al.; U.S. Pat. No. 4,307,143 to Meitner, et al.; and U.S. Pat. No. 4,707,398 to Wisneski, et al., which are incorporated herein in their entirety by reference thereto for all purposes. Meltblown fibers may be substantially continuous or discontinuous, and are generally tacky when deposited onto a collecting surface.

As used herein, the term “spunbond” web or layer generally refers to a nonwoven web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond filaments are generally not tacky when they are deposited onto a collecting surface. Spunbond filaments may sometimes have diameters less than about 40 micrometers, and are often between about 5 to about 20 micrometers. The continuous filaments may, for example, have a length much greater than their diameter, such as a length to diameter ratio (“aspect ratio”) greater than about 15,000 to 1, and in some cases, greater than about 50,000 to 1.

The term “(meth)acrylic polymer” refers to both acrylic polymers and methacrylic polymers.

In the present disclosure, when a layer is being described as “on” or “over” another layer, it is to be understood that the layers can either be directly contacting each other or have another layer or feature positioned therebetween. Thus, these terms are simply describing the relative position of the layers to each other and do not necessarily mean “on top of since the relative position above or below depends upon the orientation of the device to the viewer.

### Test Methods

Alcohol Repellency: The alcohol repellency test is designed to measure the resistance of nonwoven fabrics to penetration by low surface tension liquids, such as alcohol/water solutions. Alcohol repellency was tested according to the test procedure described as follows. In this test, a fabric's resistance to penetration by low surface energy fluids is determined by placing 0.1 ml of a specified volume percentage of isopropyl alcohol (IPA) solution in several different locations on the surface of the fabric and leaving the specimen undisturbed for 5 minutes. In this test, 0.1 ml of serially diluted isopropyl alcohol and distilled water solutions, ranging from 60 volume percent to 100 volume percent in increments of 10 percent, are placed on a fabric sample arranged on a flat surface. After 5 minutes, the surface is visually inspected and the highest concentration retained by the fabric sample is noted. For example, if the minimum value is a 70% IPA solution, i.e. a 70% IPA solution is retained by the fabric but an 80% solution penetrates through the fabric to the underlying surface. The grading scale ranges from 0 to 5, with 0 indicating the IPA solution wets the fabric and 5 indicating maximum repellency. Unless stated otherwise, the percent alcohol (IPA) repellency reported indicates the maximum volume percent of IPA that could be added to water while still retaining a 5 rating on the scale at all points of the fabric tested. This procedure is a modification of INDA Standard Test No. 1ST 80.9-74 (R-82).

ASTM-F903-10 Method C—Standard for Resistance of Material used in Protective Clothing. It is desirable to have a material that passes the list of solvents defined in ASTM F-903 using methods C (without pressure).

The so-called Gutter Test, EN 6530-2005, is another test method for resistance of a material to penetration of liquids.

Oil repellency is measured by a method according to the AATCC-118-1981. Solvents of different surface tension are placed on the sample and the sample is scored according to the solvent of lowest surface tension that does not penetrate the sample. A treated fabric that is not penetrated by Nujol™ (Plough Inc., cas number 8042-47-5), having the lowest penetrating power, is rated as score 1, and a treated fabric that is not penetrated by heptane, having the highest penetrating power in test oils, is rated as score 8. (See also, U.S. Pat. No. 5,132,028 for a description of this procedure, which is incorporated by reference herein).

### DETAILED DESCRIPTION

Generally speaking, the present invention is directed to methods of forming a fluorinated polymeric coating over at least one surface of a multi-layered nonwoven laminate. For example, the nonwoven laminate may contain a meltblown web and spunbond web (e.g., a SM laminate, a SMS laminate, a SMMS laminate, etc.). In one embodiment, for example, the laminate contains a meltblown web positioned between two spunbond webs to form a spunbond/meltblown/spunbond (“SMS”) laminate, as described in greater detail below. For instance, the fluorinated polymeric coating can be formed over an exposed surface of a spunbond web on the laminate.

The present invention is also directed to multi-layered nonwoven laminates having a fluorinated polymeric coating over at least one surface (e.g., over an exposed surface of the spunbond web). The fluorinated polymeric coating can provide sufficient barrier resistance to organic solvents (e.g., alcohols, hydrocarbon oils, etc.).

For example, the nonwoven web having a fluorinated polymeric coating over at least one surface can have an alcohol repellency of greater than 80%, such as greater than about 90%, such as greater than about 95%. Additionally, in some embodiments, the nonwoven web can pass the ASTM-F903-10, Method C, for solvent repellency without pressure for other chemicals, such as acetonitrile, dimethylformamide, methanol, carbon disulfide, nitrobenzene, sulfuric acid 98%, sulfuric acid 30%, sodium hydroxide 50%, and/or sodium hydroxide 10%. The nonwoven webs can also be rated according to pass the Gutter test method and have a class rating of at least Class 1, preferably at least Class 3.

In particular embodiments, the nonwoven web having a fluorinated polymeric coating can have an oil repellency rating of at least 1, such as 7 to 8 or higher.

I. Fluorinated Polymeric Coating

According to the present invention, the fluorinated polymeric coating contains a polymerized (meth)acrylate monomer having a perfluoroalkyl side group of 1 to 6 carbons on the surface of the laminate to graft the polymeric coating thereto. For example, the fluorinated polymeric coating can have a (meth)acrylic polymer backbone from which a plurality of perfluoroalkyl side groups of 1 to 6 carbons extend, either directly or indirectly through an alkyl group (e.g., having 1 to 4 carbons). In one particular embodiment, the perfluoroalkyl side groups have a length of 6 carbon atoms extending from the (meth)acrylic polymer backbone.

Surprisingly, it has been unexpectedly discovered that a nonwoven web having a fluorinated polymeric coating including the perfluoroalkyl(alkyl)(meth)acrylate polymer with perfluoroalkyl side groups defined by 1 to 6 carbon atoms (and, in particular embodiments, by 2, 4, or 6 carbon atoms) can be formed to have substantially identical barrier properties to organic solvents (e.g., isopropyl alcohol) than an otherwise identical nonwoven web but having a fluorinated polymeric coating including perfluoroalkyl side groups defined by 8 carbon atoms. Thus, a nonwoven web has been discovered that can achieve the desired repellency properties without the use and/or presence of a PFOA anywhere in the manufacturing process.

The perfluoroalkyl side groups having 1 to 6 carbon atoms can be shown structurally in Formula 1:

—(CF₂)_{z}—F (Formula 1A)

where z is 1 to 6. In particular embodiments, z can be 2, 4, or 6, and these perfluoroalkyl side groups can be referred to as C2, C4, and C6, respectively, referencing the number of perfluorinated carbons in the chain. It should be noted that the perfluoroalkyl side group of Formula 1A (and the other Formulas of the present disclosure) can be more commonly shown according to Formula 1 B, which is intended to be the same structure as Formula 1A:

—(CF₂)_{z′}—CF₃ (Formula 1B)

where z′ is 0 to 5 (e.g., 1, 3, or 5). Formula 1A is simply shown with the terminal fluorinated carbon (—CF₃) as part of the perfluoroalkyl chain (i.e., as —CF₂—F) such that the value of z of Formula 1A corresponds to the total number of carbons in the perfluoroalkyl chain.

As stated, the perfluoroalkyl side groups can be bonded to the (meth)acrylic polymer backbone directly or indirectly. In one particular embodiment, the perfluoroalkyl side groups can be bonded through an alkyl group of 1 to 22 carbons, such as shown in Formula 2 below. However, other linking moieties can indirectly link the perfluoroalkyl side groups and the polymer backbone as discussed below.

Suitable perfluoroalkyl(alkyl)(meth)acrylic monomers include perfluoroalkyl(alkyl)(meth)acrylate esters having a perfluorinated carbon end group with 1 to 6 carbon atoms. For example, the perfluoroalkyl(alkyl)(meth)acrylic monomers can have the structure shown in Formula 2:

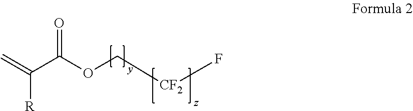

where R is H or CH₃; y is an integer from 0 to 22 (e.g., 2 to 12); and z is an integer from 1 to 6 (e.g., 2, 4, or 6). In particular embodiments, y is 2 to 4 (e.g., 2) and/or z is 6.

In alternative embodiments, the ester linkage between the perfluoroalkyl group and the acrylic double bond (as shown in Formula 2) can be an amide, a sulfonamide, an ether, an imide, a urethane, a saturated or unsaturated 6 membered ring structure (e.g., styrenic or phenilic groups), or other suitable moieties.

Monomers of this type may be readily synthesized by one of skill in the chemical arts by applying well-known techniques. Additionally, many of these materials are commercially available. For example, fluoroacrylate monomers under the trade names Capstone® 62-AC and Capstone® 62-MA (DuPont Corporation of Wilmington, Del.) and Unidyne® TG 20 and Unidyne® TG 30 (Daikin Americas, Inc. of Orangeburg, N.Y.) may be used in the practice of the present invention.

In one particular embodiment, the perfluoroalkyl(alkyl)(meth)acrylate polymer is a homopolymer (i.e., containing only a single type of perfluoroalkyl(alkyl)(meth)acrylate monomer). Alternatively, the perfluoroalkyl(alkyl)(meth)acrylate polymer can be a copolymer formed through a mixture of perfluoroalkyl(alkyl)(meth)acrylate monomers corresponding to different values of y and/or z within the ranges given below with respect to Formula 2. As such, in these embodiments, perfluoroalkyl(alkyl)(meth)acrylate polymer can be substantially free from monomers outside of the Formula 2 (i.e., the perfluoroalkyl(alkyl)(meth)acrylate polymer includes greater than about 99% by weight perfluoroalkyl(alkyl)(meth)acrylate monomers according to Formula 2).

However, in other embodiments, the perfluoroalkyl(alkyl)(meth)acrylate polymer can be a copolymer formed from a perfluoroalkyl(alkyl)(meth)acrylate monomer(s), as in Formula 2, combined with other types of monomers (e.g., other (meth)acrylic monomers).

It should be also recognized that the fluorinated polymeric coating may be highly branched and grafted (e.g., covalently bonded) to the fibers (e.g., crosslinked to the polymeric material of the fibers) upon polymerization.

II. Polymerization on the Nonwoven Web

In one particular embodiment, the perfluoroalkyl(alkyl)(meth)acrylate polymer can be formed on the nonwoven web by deposition and subsequent grafting of suitable perfluoroalkyl(alkyl)(meth)acrylic monomers to the web via irradiation from a high energy source (e.g., plasma, gamma, and UV rays and electron beam). The monomer deposition process generally involves (1) atomization or evaporation of the monomers in a vacuum chamber, (2) condensation of the monomers on the nonwoven laminate, and (3) polymerization of the monomers by exposure to a high energy source, such as plasma, electron beam, gamma radiation, or ultraviolet radiation.

No matter the particular perfluoroalkyl(alkyl)(meth)acrylic monomer used, the perfluoroalkyl(alkyl)(meth)acrylic monomer is evaporated (or atomized) and condensed (or sprayed) on the porous substrate according to a monomer deposition process. A high energy source (e.g., a radio frequency plasma) can then initiate graft polymerization of the monomer onto the surfaces of the web, including within pores and other void space between the fibers, that can be reached by the activated monomer chemistry. The level of liquid repellency achieved by plasma polymerization of the laminate may depend, in part, upon the amount of perfluoroalkyl(alkyl)(meth)acrylic monomer that has been deposited (e.g., condensed) and graft copolymerized on the surface of the laminate. Various references are available which describe, in detail, plasma fluorination processes. For example, US 20030134515 and EP 1 557 489 disclose plasma fluorination processes.

While a variety of plasma fluorination processes are available, one particularly suitable plasma fluorination processes used to treat the laminate for repellency to oils is through generating plasma in a vacuum chamber using a radio frequency (RF) plasma generator. A gas or vapor, such as, for example, containing a perfluoroalkyl(alkyl) (meth)acrylic monomer, is introduced (e.g., flash-evaporated) into the chamber and allowed to deposit (e.g., condense) on the surface of the web. The plasma then initiates the graft polymerization of the monomer onto the surfaces of the laminate via exposure to the plasma. Plasma can be created with a wide variety of electrical energy; DC (direct current) as well as AC (alternating current) over a very large range of frequencies typically referred to as low frequency, radio frequency, microwave and even higher frequencies in the electromagnetic spectrum. In the studies conducted herein and discussed in the Examples below, high frequency RF was employed, specifically 13.56 MHz. However, it is not intended to preclude other frequencies that may prove equally useful.

For example, in this monomer deposition process, a conventional commercial vacuum plasma system (Plasma Science PS0500 available from 4th State, Inc., Belmont, Calif.) can be modified to allow pulse plasma vis-à-vis continuous wave as well as allow the introduction of liquid monomer vapors and can be used to enable a plasma pretreatment, followed by plasma polymerization and deposition of a functional coating on a porous substrate in a continuous process.

Referring to FIG. 7, for example, a system 100 is shown for deposition and polymerization of the fluorinated polymeric coating. The system includes a deposition chamber 102 for treating the nonwoven web 12 being spooled continuously between a feed reel 104 and a product reel 106. As shown, the nonwoven web 12 is unwound from the feed roll 104 and passed through the deposition chamber 102 for condensation deposition of the vaporized perfluoroalkyl(alkyl)(meth)acrylic monomers while simultaneously being exposed to the plasma glow discharge for polymerization of the monomers on the nonwoven web 12. Tension rollers 120 are also shown controlling the tension of the web 12 as it passes through the deposition chamber 102.

The plasma can generally be generated through applying power from the power source 107 to electrodes 108, 110 within the chamber 102.

In general, the deposition chamber 102 can be under a vacuum pressure during the deposition and polymerization process, as controlled by vacuum pump 112. For example, the deposition pressure within the deposition chamber can be about 1 millitorr to about 200 millitorr, although values outside this range may also be utilized. In some embodiments, the deposition pressure may be about 10 millitorr to about 100 millitorr, and in other embodiments from about 40 millitorr to about 90 millitorr.

Monomers can be introduced within the deposition chamber 102 from source tank 114 through feed tube 116. The flow rate of the monomer can be controlled by valve 118.

The high energy treatment (e.g., plasma) can simultaneously generate radicals on the surface of the nonwoven web 12, which can subsequently enhance surface attachment through covalent bonding of the polymerizing fluorinated monomer(s) being exposed to the high energy treatment. As stated, the high energy source causes a reaction between the deposited perfluoroalkyl(alkyl)(meth)acrylic monomer and polymers of the nonwoven laminate surface. As a result, the perfluoroalkyl(alkyl)(meth)acrylic monomer may become graft copolymerized with (i.e., grafted or otherwise crosslinked to) the polymer fibers of the outer spunbond layer.

In one embodiment, the high energy treatment can be pulsed such that the discharge time is intermittent through the deposition process. For example, the duty cycle can be about 0.01% to about 5%, such as about 0.1 to about 2%. As used herein, the “duty cycle” refers to the ratio of the plasma on time (i.e. discharge time) to a sum of the plasma-on time and the plasma-off time (i.e. non-discharge time). For example, if the plasma on time is on for 0.5 ms and off for 9.5 ms, then the duty cycle is 0.5% (i.e., 0.5 divided by (05 +9.5) times 100).

The efficacy or efficiency of the high energy treatment may be varied in a controlled manner across at least one dimension of the fibrous web. For example, the strength of the high energy treatment can be readily varied in a controlled manner by known means. Delivered power, frequency, monomer delivery rate, co-process delivery rate, pressure, substrate residence time, gas residence time are all variables the parameters of which are controllable by the equipments design and operating parameters. For the specific chambers employed in the examples discussed below, it was found that power level and/or pulse frequency may be adjusted according to a function of the pressure within the deposition chamber. For example, when using relatively high pressures during reaction (e.g., about 50 mTorr to about 125 mTorr, such as about 60 to about 85 mTorr), the power level can be about 100 Watts to about 500 Watts (e.g., about 150 Watts to about 400 Watts, such as about 200 Watts to about 300 Watts) at a pulsing frequency of about 50 Hz to about 500 Hz, such as about 75 Hz to about 150 Hz. Pulsing frequency is the on/off rate at which the plasma power is being delivered to the plasma chamber. However for any given chamber geometry, electrode area and plasma volume, there is a “sweet spot” for power density and duty cycle. In other embodiments, higher power levels can also be used with these same parameters, such as about 2000 Watts to about 5000 Watts (e.g., about 2500 Watts to about 4500 Watts). Also inert gases such as argon can be used to modify pressure inside the chamber along with a throttle valve to increase residence time of the monomer in the chamber. It should be understood by those skilled in the art that controlling gas flow with a throttle valve increase monomer residence time and under certain circumstances may enhance the efficiency of the plasma grafting process.

In selected embodiments, the reaction time may vary from about 10 seconds to about 60 minutes or longer if necessary, depending on the size of the reactor and the number of samples inside the plasma reactor, the power level and frequency of the high energy treatment, etc. Other fluorinated gases and fluorine precursors may also be used in the plasma treatment process.

The amount and thickness of the fluorinated polymeric coating on the surface of the laminate can be controlled by adjusting the deposition rate and/or speed of the web traveling through the deposition area. In one particular embodiment, the fluorinated polymeric coating is applied to the surface of the laminate in an add-on amount of about 0.01% to about 0.5% by weight. The thickness of the fluorinated coating can be about 10 nm to about 1000 nm. Higher add-on levels or thicker coatings are also possible by adjusting flow rate, power input and line speed.

It has been surprisingly found that the processing conditions used to form the fluorinated polymeric coating on the nonwoven web affect the barrier properties of the resulting web. In particular, the polymerization technique and conditions for forming the perfluoroalkyl(alkyl)(meth)acrylate polymer with perfluoroalkyl side groups having a length from 1 to 6 carbons has surprising been found to allow the resulting polymer to exhibit repellency properties for organic solvents (e.g., alcohol) that were previously thought unachievable except through the use of (meth)acrylate polymers having perfluoroalkyl side groups with a length of 8 carbons or more. Accordingly, the present inventors have surprisingly found that the web coated with the perfluoroalkyl(alkyl)(meth)acrylate polymer having perfluoroalkyl side groups that are from 1 to 6 carbons in length can exhibit an alcohol repellency of greater than about 80% (using the alcohol repellency test explained above, an alcohol repellency of 80% means a that a 80% solution of IPA scores a 5), such as greater than about 90%, and greater than about 95%. In one particular embodiment, the web can exhibit an alcohol repellency of about 100%, indicating that the web or laminate exhibits maximum repellency (i.e., a score of 5 on the scale of 0-5) for a 100% solution of IPA.

In particular, it has been found that specific control of various processing variables (e.g., the monomer composition, the localized pressures within the treatment chamber where the substrate is present and the monomer is delivered, the atmosphere within the treatment chamber (e.g., an inert atmosphere), the power input, dwell time, etc.) can result in a nonwoven web having a alcohol repellency properties substantially equivalent to those of a (meth)acrylic polymer having a perfluoroalkyl side chain with a length of 8 carbons or more.

As such, in one particular embodiment, the monomers can be deposited onto the surface of the nonwoven web without a crosslinker, catalyst, or other polymerizing agent. For example, the monomers can be deposited onto the surface as a neat monomer composition that is substantially free from any additional components (i.e., consisting of the perfluoroalkyl(alkyl)(meth)acrylic monomers).

Additionally, the flash and/or deposition atmosphere can be substantially free of oxygen, and in one embodiment, can be completely inert (e.g., containing an inert gas such as argon).

In one embodiment, it may be desirable to pretreat the web through exposure to a pretreatment energy source prior to deposition and polymerization with the high energy source. For example, the web can be first exposed to a first high-energy treatment (such as a glow discharge (GD) from a or plasma (e.g., RF) treatment system), followed by the simultaneous high energy treatment and deposition (e.g., a pulsed RF plasma) of the perfluoroalkyl(alkyl)(meth)acrylic monomers, as discussed above, for graft polymerization on the surface of the fibers of the nonwoven web. The Accordingly, this embodiment can involve a series of high energy treatments, where the nonwoven web is subjected to a particular combination of high-energy treatments to impart the alcohol and oil repellency to the web. The pre-treatment step(s) can “prime” the substrate prior to deposition and condensation of the fluorinated monomer on the substrate, Priming may involve pre-treating the substrate in oxygen (or other oxidizing agents) plasma to oxidize and degraded any contaminants that may be present on the substrate and which may have negative effect on subsequent plasma fluorination as described above. Other “priming” or pre-treatment steps may also involve the use of inert gases such as argon, helium, or nitrogen to activate the surface and form transient radicals that can enhance further the plasma-induced graft polymerization and fluorination process. For example, the pretreatment may be performed by exposing the web to a plasma of oxygen (O₂) or other activating compound to provide for an activated surface on the web for facilitated grafting of the monomer thereto.

III. Nonwoven Webs

As stated, the nonwoven laminate having the fluorinated polymeric coating over at least one surface contains a meltblown layer and spunbond layer. The fluorinated polymeric coating is generally applied to an outer surface of the nonwoven laminate to maximize the barrier properties it provides.

In one embodiment, for example, the laminate contains a meltblown web positioned between two spunbond webs to form a spunbond/meltblown/spunbond (“SMS”) laminate.

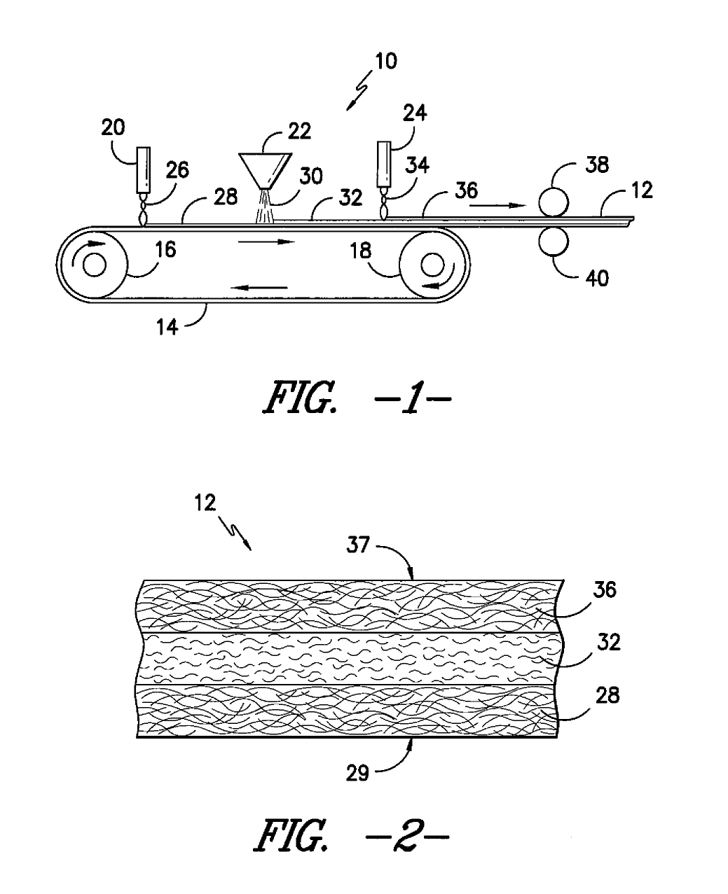

Referring to FIG. 1, one embodiment of a forming machine 10 is shown for producing an exemplary SMS laminate 12 having a meltblown layer 32 positioned between spunbond layers 28 and 36. The forming machine 10 includes an endless foraminous surface 14 (e.g., belt) wrapped around rollers 16 and 18 so that the surface 14 is driven in the direction shown by the arrows. In this embodiment, the illustrated forming machine 10 employs a first spunbond station 20, a meltblown station 22, and a second spunbond station 24. Alternatively, one or more of the laminate layers may be formed separately, rolled, and later converted to the laminate 12.

The spunbond stations 20 and 24 may each employ one or more conventional extruders. The extrusion temperature may generally vary depending on the type of polymers employed. The molten thermoplastic material which includes the antistatic treatment additive is fed from the extruders through respective polymer conduits to a spinneret (not shown). Spinnerets are well known to those of skill in the art. A quench blower (not shown) may be positioned adjacent the curtain of filaments extending from the spinneret. Air from the quench air blower quenches the filaments extending from the spinneret. The quench air may be directed from one side of the filament curtain or both sides of the filament curtain. Such a process generally reduces the temperature of the extruded polymers at least about 100° C. over a relatively short time frame (seconds). This will generally reduce the temperature change needed upon cooling, to preferably be less than 150° C. and, in some cases, less than 100° C. The ability to use relatively low extruder temperature also allows for the use of lower quenching temperatures. For example, the quench blower may employ one or more zones operating at a temperature of from about 20° C. to about 100° C., and in some embodiments, from about 25° C. to about 60° C.

After quenching, the filaments are drawn into the vertical passage of the fiber draw unit by a flow of a gas such as air, from a heater or blower through the fiber draw unit. The flow of gas causes the filaments to draw or attenuate which increases the molecular orientation or crystallinity of the polymers forming the filaments. Fiber draw units or aspirators for use in melt spinning polymers are well known in the art. Suitable fiber draw units for use in the process of the present invention include a linear fiber aspirator of the type shown in U.S. Pat. No. 3,802,817, which is incorporated herein in its entirety by reference thereto for all relevant purposes. Thereafter, the filaments 26 are deposited through the outlet opening of the fiber draw unit and onto the foraminous surface 14 to form the spunbond layers 28.

Referring again to FIG. 1, the meltblown station 22 includes a single die tip, although other meltblown die tips may of course be employed. As the polymer exits the die, high pressure fluid (e.g., heated air) attenuates and spreads the polymer stream into microfibers 30. The microfibers 30 are randomly deposited onto the spunbond layer 28 to form the meltblown layer 32. The distance between the die tip and the foraminous surface 14 is generally small to improve the uniformity of the fiber laydown. For example, the distance may be from about 1 to about 6 centimeters. After the meltblown layer 32 is deposited, the spunbond station 24 deposits spunbond filaments 34 onto the meltblown layer 32 as described above to produce the spunbond layer 36.

Once formed, the nonwoven laminate is then bonded using any conventional technique, such as with an adhesive or autogenously (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with the aliphatic polyester(s) used to form the fibers. Suitable autogenous bonding techniques may include ultrasonic bonding, thermal bonding, through-air bonding, and so forth.

In FIG. 1, for instance, the SMS laminate passes through a nip formed between a pair of rolls 38 and 40, one or both of which are heated to melt-fuse the fibers. One or both of the rolls 38 and 40 may also contain intermittently raised bond points to provide an intermittent bonding pattern. The pattern of the raised points is generally selected so that the nonwoven laminate has a total bond area of less than about 50% (as determined by conventional optical microscopic methods), and in some embodiments, less than about 30%. Likewise, the bond density is also typically greater than about 100 bonds per square inch, and in some embodiments, from about 250 to about 500 pin bonds per square inch. Such a combination of total bond area and bond density may be achieved by bonding the web with a pin bond pattern having more than about 100 pin bonds per square inch that provides a total bond surface area less than about 30% when fully contacting a smooth anvil roll. In some embodiments, the bond pattern may have a pin bond density from about 250 to about 350 pin bonds per square inch and a total bond surface area from about 10% to about 25% when contacting a smooth anvil roll. Exemplary bond patterns include, for instance, those described in U.S. Pat. No. 3,855,046 to Hansen et al., U.S. Pat. No. 5,620,779 to Levy et al., U.S. Pat. No. 5,962,112 to Haynes et al., U.S. Pat. No. 6,093,665 to Sayovitz et al., U.S. Design Pat. No. 428,267 to Romano et al. and U.S. Design Pat. No. 390,708 to Brown, which are incorporated herein in their entirety by reference thereto for all purposes.

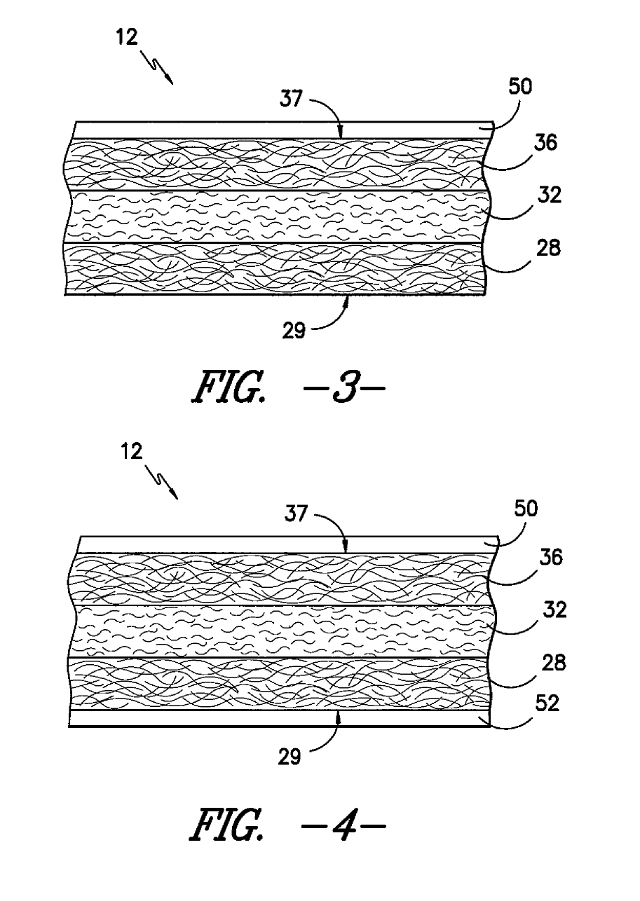

One embodiment of the SMS laminate 12 formed according to the process shown in FIG. 1 is shown in greater detail in FIG. 2. As illustrated, the meltbiown layer 32 is positioned between two spunbond layers 28 and 36.

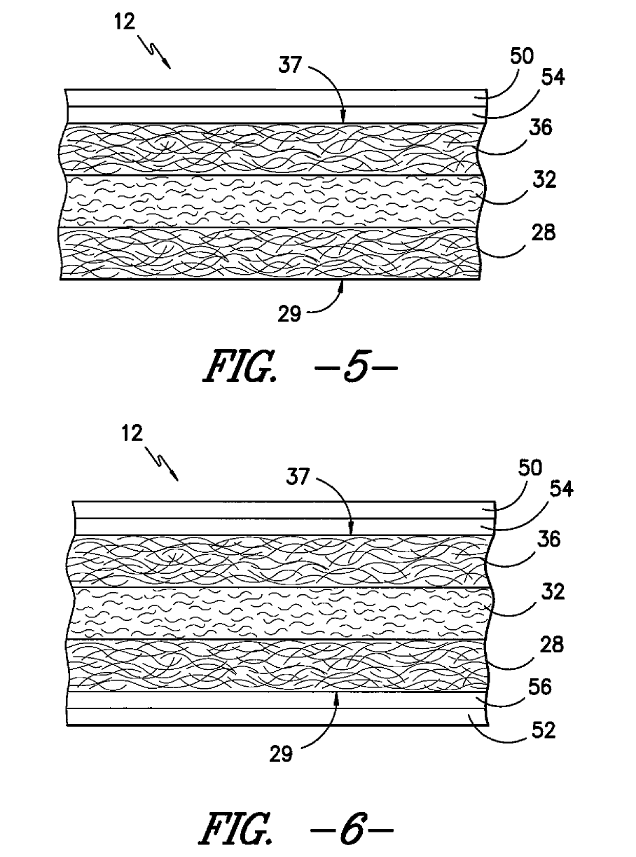

FIG. 3 shows an embodiment of an SMS laminate 12 after formation of the fluorinated polymeric coating 50, as discussed above, on the surface 37 of the spunbond layer 36. FIG. 4 shows another embodiment of an SMS laminate 12 having a first fluorinated polymeric coating 50 on the first surface 37 of the spunbond layer 36, and a second fluorinated polymeric coating 52 on the surface 29 of the spunbond layer 28.

In one particular embodiment, the nonwoven webs are constructed from synthetic, polymeric. For example, the thermoplastic polymeric material used to form the nonwoven web can generally be hydrophobic. In addition, the fibers of the nonwoven web are primarily hydrophobic synthetic fibers. For example, greater than about 90% of the fibers of the web can be hydrophobic synthetic fibers, such as greater than about 95%. In one embodiment, substantially all of the fibers of the nonwoven web (i.e., greater than about 98%, greater than about 99%, or about 100%) are hydrophobic synthetic fibers.

Exemplary synthetic polymers for use in forming nonwoven web may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. It should be noted that the polymer(s) may also contain other additives, such as processing aids or treatment compositions to impart desired properties to the fibers, residual amounts of solvents, pigments or colorants, and so forth.

Monocomponent and/or multicomponent fibers may be used to form the nonwoven web. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. No. 5,336,552 to Strack, et al., U.S. Pat. No. 5,108,820 to Kaneko, et al., U.S. Pat. No. 4,795,668 to Kruege, at al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

Although any combination of polymers may be used, the polymers of the multicomponent fibers are typically made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 5% to about 80%, and in some embodiments, from about 10% to about 60% by weight of the low melting polymer. Further, the multicomponent fibers may have from about 95% to about 20%, and in some embodiments, from about 90% to about 40%, by weight of the high melting polymer. Some examples of known sheath-core bicomponent fibers available from KoSa Inc. of Charlotte, North Carolina under the designations T-255 and T-256, both of which use a polyolefin sheath, or T-254, which has a low melt co-polyester sheath. Still other known bicomponent fibers that may be used include those available from the Chisso Corporation of Moriyama, Japan or Fibervisions LLC of Wilmington, Del.

Sheath/core bicomponent fibers where the sheath is a polyolefin such as polyethylene or polypropylene and the core is polyester such as poly(ethylene terephthalate) or poly(butylene terephthalate) can also be used to produce the nonwoven fabrics. The primary role of the polyester core is to provide resiliency and thus to maintain or recover bulk under/after load.

Suitable multi-layered materials may include, for instance, spunbond/meltblown/spunbond (SMS) laminates and spunbond/meltblown (SM) laminates. Various examples of suitable SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

Another example of a multi-layered structure is a spunbond web produced on a multiple spin bank machine in which a spin bank deposits fibers over a layer of fibers deposited from a previous spin bank. Such an individual spunbond nonwoven web may also be thought of as a multi-layered structure. In this situation, the various layers of deposited fibers in the nonwoven web may be the same, or they may be different in basis weight and/or in terms of the composition, type, size, level of crimp, and/or shape of the fibers produced. As another example, a single nonwoven web may be provided as two or more individually produced layers of a spunbond web, a carded web, etc., which have been bonded together to form the nonwoven web. These individually produced layers may differ in terms of production method, basis weight, composition, and fibers as discussed above.

In one particular embodiment, the fluorinated polymeric coating is applied to a spunbond web or a laminate having an outer surface defined by a spunbond web (e.g., an SMS laminate). Although the spunbond web can be made by conventional processes, in some cases it may be either desirable or necessary to stabilize the nonwoven fabric by known means, such as thermal point bonding, through-air bonding, and hydroentangling.

As stated, the spunbond web can primarily include synthetic fibers, particularly synthetic hydrophobic fibers, such as polyolefin fibers. In one particular embodiment, polypropylene fibers can be used to form the nonwoven web. The polypropylene fibers may have a denier per filament of about 1.5 to 2.5, and the nonwoven web may have a basis weight of about 17 grams per square meter (0.5 ounce per square yard). In one particular embodiment, the spunbond web can be added to other layers to form a nonwoven laminate. For example, the nonwoven laminate can contain a meltblown layer and spunbond layer. The techniques used to form the nonwoven laminate generally depend on the desired configuration. In one embodiment, for example, the nonwoven laminate contains a meltblown layer positioned between two spunbond layers to form a spunbond I meltblown/spunbond (“SMS”) laminate. Various techniques for forming SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al., as well as U.S. Patent Application Publication No. 2004/0002273 to Fitting, et al., all of which are incorporated herein in their entirety by reference thereto for all purposes. Of course, the nonwoven laminate may have other configuration and possess any desired number of meltblown and spunbond layers, such as spunbond/meltblown/meltblown/spunbond laminates (“SMMS”), spunbond/meltblown laminates (“SM”), etc.

If desired, the nonwoven laminate of the present invention may be applied with various other treatments to impart desirable characteristics. For example, the laminate may be treated with surfactants, colorants, antifogging agents, lubricants, and/or antimicrobial agents. In one particular embodiment, an antistatic agent can be included within the fibers of the web, as disclosed in U.S. Publication No. 2009/0156079 of Yahiaoui, et al., the disclosure of which is incorporated herein by reference.

In one particular embodiment, the nonwoven web can be precoated with a thin metalized layer prior to formation of the fluorinated polymeric coating to achieve superior surface resistivity. This metalized layer is generally thin enough to allow for the subsequently deposited perfluoroalkyl(alkyl)(meth)acrylic monomers to still graft (or otherwise covalently bond) to the polymers on the surface of the laminate upon polymerization, as discussed above. As such, the metalized layer can have a thickness of about 1 nanometer (nm) to about 1 micrometer (μm), such as about 10 nm to about 250 nm.

The metalized layer can include gold, silver, aluminum, chromium, copper, iron, zirconium, platinum, nickel, titanium, oxides of these metals, or combinations thereof. In one embodiment, the metalized layer can be applied to the surface of the laminate while still hot, to ensure adherence of the metals to the laminate, although any suitable method of forming the metalized layer on the laminate may be utilized.

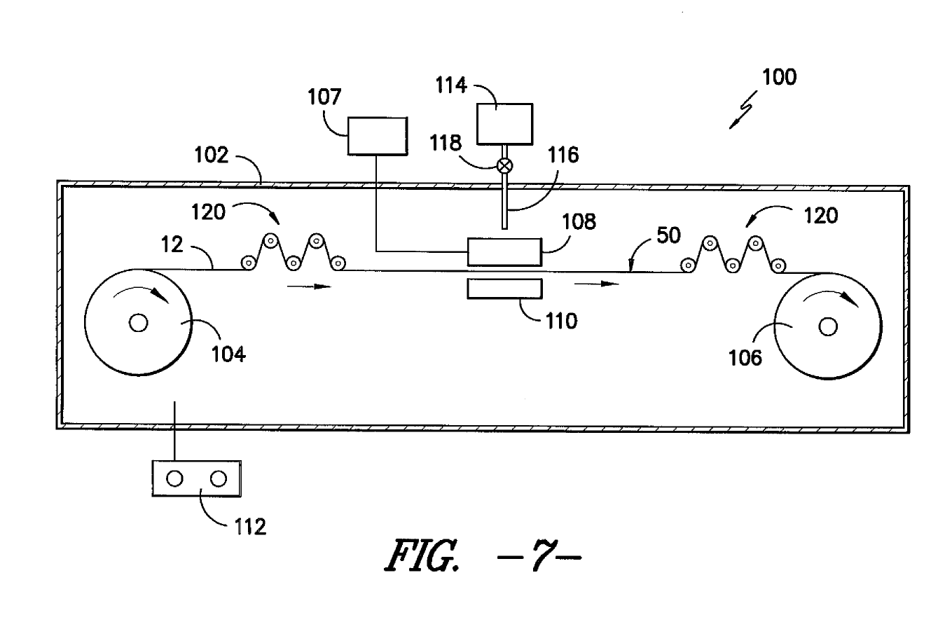

For example, FIG. 5 shows an alternative embodiment of the laminate 12 shown in FIG. 3 in that a metalized layer 54 is between the spunbond layer 36 and the fluorinated polymeric coating 50. Similarly, FIG. 6 shows an alternative embodiment of the laminate 12 shown in FIG. 4 in that a first metalized layer 54 is between the spunbond layer 36 and the fluorinated polymeric coating 50, and a second metalized layer 56 is between the spunbond layer 28 and the fluorinated polymeric coating 52.

The nonwoven laminate of the present invention may be used in a wide variety of applications. For example, the laminate may be incorporated into a “medical product”, such as gowns, surgical drapes, facemasks, head coverings, surgical caps, shoe coverings, sterilization wraps, warming blankets, heating pads, and so forth. Of course, the nonwoven laminate may also be used in various other articles. For example, the nonwoven laminate may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art. Absorbent articles, for instance, typically include a substantially liquid-impermeable layer (e.g., outer cover), a liquid-permeable layer (e.g., bodyside liner, surge layer, etc.), and an absorbent core. In one embodiment, for example, the nonwoven laminate of the present invention may be used to form an outer cover of an absorbent article.

Although the basis weight of the nonwoven laminate of the present invention may be tailored to the desired application, it generally ranges from about 10 to about 300 grams per square meter (“gsm”), in some embodiments from about 25 to about 200 gsm, and in some embodiments, from about 40 to about 150 gsm.

The present invention may be better understood with reference to the following examples.

### EXAMPLE 1

In this Example, a 6″×6″ section of an SMS web was positioned in the middle of the plasma chamber and was subjected to process conditions set forth in Table 1. The processing conditions and results of Example 1 are shown in Table 1. As shown, the variables included the monomer, the pressure within the chamber, the power/frequency of the plasma, and the duration of exposure to the plasma. Samples A-G were run according to the following discussion.

The process of Example 1 generally involved two steps (Steps I and II). In step I, a reactor (i.e., the deposition chamber) was evacuated to about 40 millitorr. An RF field was then applied to electrodes which were positioned within the reactor, and a plasma was established to act as a charge carrier between the electrodes. Thirty (30) standard cubic centimeters (“sccm”) of argon was pumped into the chamber. The stated monomer was then added to the chamber at the stated rate (fifteen (15) ml/hour). The stated power at the stated frequency was then applied at the stated duty cycle for the stated duration, causing the monomer to polymerize on the surface of the laminate.

Step II involved purging the chamber with argon at the stated rate and for the stated duration, with the reactor in an unpowered condition. This step purged the chamber and brought the chamber to atmospheric pressure permitting access to the samples. The treated samples were removed from the plasma chamber and tested for liquid repellency.

Each sample is discussed in greater detail below:

Sample A: Comparative Sample of a C8 Monomer

As shown in Table 1, Step A of Sample A involved evacuating a reactor (i.e., the deposition chamber) to about 40 millitorr. An RF field was applied to electrodes which were positioned within the reactor, and a plasma was established to act as a charge carrier between the electrodes. Thirty (30) standard cubic centimeters (“sccm”) of argon was pumped into the chamber. Perfluorododecyl acrylate (PFDEA) from Apollo Chemical Co., LLC. (Burlington, N.C.) was also added to the chamber at a rate of fifteen (15) ml/hour. A power of 100 watts at 100 Hz was applied at a duty cycle of 0.5% for five minutes. The PFDEA monomer was flash-evaporated and exposed to plasma initiation for graft polymerization of the PFDEA (a “C8” bench mark fluorinated monomer) onto the surface of the nonwoven including pore surfaces.

In Step B, 100 sccm of argon was fed into the reactor and was held in the reactor for two minutes, with the reactor in an unpowered condition. This step purged the chamber and brought the chamber to atmospheric pressure permitting access to the samples. The treated samples were removed from the plasma chamber and tested for liquid repellency. Sample A showed repellency to 100% IPA.

Sample B: Comparative Example of a C6 Monomer

Sample 2 was an attempt to use process conditions of Sample A (with the C8 momomer) on a C6 monomer (Unidyne® TG 20, Daikin Americas, Inc. of Orangeburg, N.Y.). The same processing conditions were used according to Comparative Example 1. The resulting web showed repellency to only 20% IPA as shown in Table 1.

Samples C-E

Samples C through E surprisingly revealed that the repellency can be increased using the TG 20 monomer (or C6) through a combination of higher plasma power and exposure time at a pressure of 40 mtorr.

Samples F-G

Examples F-G surprisingly indicated that operating at a higher pressure range of about 70-85 mtorr, and at similar plasma power as examples C, D, and E and shorter exposure time can achieve 100% IPA repellency. Note that step B (unpowered) in examples F and G was 3 times longer to insure complete purging of any residual unreacted monomer, if any.

TABLE 1

| | | | | | | | | Duration | |
|---|---|---|---|---|---|---|---|---|---|
| | | | Liquid | Pressure | | | Duty | of Step | IPA |
| Sample | Step | Gas | (monomer) | (mtorr) | Power | | Cycle | (min.) | repellency |
| A | I | 30 sccm Ar | PFDEA at | 40 | 400 | W, | 0.50% | 10 | |
| | | | 15 ml/hr. | | 100 | Hz | | | |
| | II | 100 sscm Ar | None | | 0 | | n/a | 2 | 100% |
| B | I | 30 sccm Ar | TG 20 at | 40 | 400 | W, | 0.50% | 10 | |
| | | | 15 ml/hr. | | 100 | Hz | | | |
| | II | 100 sscm Ar | None | | 0 | | n/a | 2 | 20% |
| C | I | 30 sccm Ar | TG 20 at | 40 | 1000 | W, | 0.50% | 15 | |
| | | | 15 ml/hr. | | 100 | Hz | | | |
| | II | 100 sscm Ar | None | | 0 | | n/a | 2 | 50% |
| D | I | 30 sccm Ar | TG 20 at | 40 | 1000 | W, | 0.50% | 20 | |
| | | | 15 ml/hr. | | 100 | Hz | | | |
| | II | 100 sscm Ar | None | | 0 | | n/a | 2 | 70% |
| E | I | 30 sccm Ar | TG 20 at | 40 | 1000 | W, | 0.50% | 40 | |
| | | | 15 ml/hr. | | 100 | Hz | | | |
| | II | 100 sscm Ar | None | | 0 | | n/a | 2 | 91% |
| F | I | 30 sccm Ar | TG 20 at | 70-85 | 1000 | W, | 0.50% | 10 | |
| | | | 15 ml/hr. | | 100 | Hz | | | |
| | II-IV | 1000 sscm Ar | None | | 0 | | n/a | 3 × 2 min | 100% |
| G | I | 30 sccm Ar | TG 20 at | 70-85 | 1000 | W, | 0.50% | 7.5 | |
| | | | 15 ml/hr. | | 100 | Hz | | | |

| | | | | | | |
|---|---|---|---|---|---|---|
| II-IV | 1000 sscm Ar | None | 0 | n/a | 3 × 2 min | 100% |

Testing revealed that a C6 monomer that is plasma polymerized can deliver 100% IPA repellency similar to a C8 monomer but under different plasma conditions that are specific to the C6 monomer. The 100% IPA repellency also goes against commonly knowledge that a C6 monomer delivers a performance that is inferior to a C8 analog.

### EXAMPLE 2

The C6 monomer was used in a 60″ wide roll-to-roll plasma machine at 4^{th} State, Inc. (Belmont, Calif.) and results are reported in Table 2. These results indicated a trend that the plasma grafting process is scalable for large webs at line speeds in a continuous operation. For example, it can be seen that a 100% IPA repellency is maintained going from trial A (at 1 fpm line speed) to faster speed (trials B, C, D and E) providing that monomer flow rate and plasma power was increased.

TABLE 2

| | | Web | | | Monomer | | | | | Duration | | |
|---|---|---|---|---|---|---|---|---|---|---|---|---|
| | Width | Speed | | | Flow rate | Pressure | Power | Freq. | Duty | of Step | | IPA |
| Trial | (In) | (fpm) | Gas | Monomer | (ml/hr) | (mTorr) | (watts) | (Hz) | Cycle | (min.) | Throttle | (%) |
| A | 24 | 1 | 150 | TG-20 | 70 | 64 | 2500 | 100 | 0.5% | 20 | No | 100 |
| | | | sccm | | | | | | | | | |
| | | | Ar | | | | | | | | | |
| B | 36 | 2 | 150 | TG-20 | 140 | 67 | 2500 | 100 | 0.5% | 10 | Yes | 100 |
| | | | sccm | | | | | | | | | |
| | | | Ar | | | | | | | | | |
| C | 36 | 4 | 150 | TG-20 | 210 | 70 | 3500 | 100 | 0.5% | 5 | Yes | 100 |
| | | | sccm | | | | | | | | | |
| | | | Ar | | | | | | | | | |
| D | 36 | 4 | 150 | TG-20 | 280 | 69 | 4500 | 100 | 0.5% | 5 | Yes | 100 |
| | | | sccm | | | | | | | | | |
| | | | Ar | | | | | | | | | |
| E1 | 60 | 4 | 150 | TG-20 | 466 | 70 | 4500 | 100 | 0.5% | 5 | Yes | 100 |
| | | | sccm | | | | | | | | | |
| | | | Ar | | | | | | | | | |
| E2 | 60 | 4 | 150 | TG-20 | 466 | 69 | 4500 | 100 | 0.5% | 5 | Yes | 100 |
| | | | sccm | | | | | | | | | |
| | | | Ar | | | | | | | | | |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of manufacturing a nonwoven web having alcohol repellency properties, the method comprising:
depositing a plurality of (meth)acrylic monomers on a surface of the nonwoven web, wherein the (meth)acrylic monomers comprise a perfluoroalkyl side group having 1 to 6 carbon atoms; and
exposing the monomers to a pulsed RF plasma to polymerize the monomers on the surface of the nonwoven web to form a fluorinated polymeric coating.

2. The method as in claim 1, wherein the (meth)acrylic monomers comprise perfluoroalkyl(alkyl)(meth)acrylic monomers.

3. The method as in claim 2, wherein the perfluoroalkyl(alkyl)(meth)acrylic monomers comprise 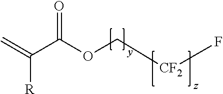
where R is H or CH₃; y is an integer from 0 to 22; and z is an integer from 1 to 6.

4. The method as in claim 3, wherein z is 6.

5. The method as in claim 3, wherein y is 2 to 12.

6. The method as in claim 1, wherein the RF plasma power is pulsed at a frequency of about 10 Hz to about 50 MHz.

7. The method as in claim 1, wherein the RF plasma power is pulsed at a frequency of about 50 Hz to about 500 Hz.

8. The method as in claim 1, further comprising:
pretreating the surface of the nonwoven web with a high-energy treatment prior to depositing the plurality of perfluoroalkyl(alkyl)(meth)acrylic monomers.

9. The method as in claim 1, wherein the pulsed RF plasma has a duty cycle of about 0.01% to about 5%.

10. The method as in claim 1, wherein the nonwoven web has an alcohol repellency of greater than 80%.

11. The method as in claim 1, further comprising:
applying a metalized layer on the surface of the nonwoven web prior to depositing the plurality of (meth)acrylic monomers.

12. A nonwoven web having alcohol repellency properties, the nonwoven web comprising a plurality of fibers and defining a surface, wherein a fluorinated polymeric coating is grafted to the surface of the nonwoven web, the fluorinated polymeric coating formed via polymerization of a plurality of (meth)acrylic monomers on the surface of the nonwoven web, wherein the (meth)acrylic monomers comprise a perfluoroalkyl side group having 1 to 6 carbon atoms;
wherein the nonwoven web has an alcohol repellency of greater than 80%.

13. The nonwoven web as in claim 12, wherein the laminate has an alcohol repellency of greater than 90%.

14. The nonwoven web as in claim 12, wherein the laminate has an alcohol repellency of greater than 95%.

15. The nonwoven web as in claim 12, wherein the (meth)acrylic monomers comprise perfluoroalkyl(alkyl)(meth)acrylic monomers.

16. The nonwoven web as in claim 15, wherein the perfluoroalkyl(alkyl)(meth)acrylic monomers comprise 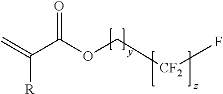
where R is H or CH₃; y is an integer from 0 to 22; and z is an integer from 1 to 6.

17. The nonwoven web as in claim 16, wherein z is 6.

18. The nonwoven web as in claim 13, wherein y is 2 to 12.

19. The nonwoven web as in claim 12, further comprising:
a metalized layer between the nonwoven web and the fluorinated polymeric coating.

20. The nonwoven web as in claim 12, wherein the perfluoroalkyl(alkyl)(meth)acrylic monomers are polymerized through exposure to a pulsed RF plasma.
